(19) United States
(12) Patent Application Publication
(10) Pub. No.: US 2025/0238478 A1
(43) Pub. Date: Jul. 24, 2025

(54) OPTIMIZATION SYSTEM, OPTIMIZATION METHOD, AND OPTIMIZATION PROGRAM

(71) Applicant: Hitachi Vantara, Ltd., Kanagawa-ken (JP)

(72) Inventors: Kazuo ONO, Tokyo (JP); Yusuke SUGITA, Tokyo (JP)

(73) Assignee: Hitachi Vantara, Ltd., (omitted)

(21) Appl. No.: 18/882,512

(22) Filed: Sep. 11, 2024

(30) Foreign Application Priority Data
Jan. 22, 2024 (JP) 2024-007549

(51) Int. Cl. G06F 17/11

(52) U.S. Cl. CPC G06F 17/11

(57) ABSTRACT

An annealing unit performs a first search for an annealing solution to lower an objective function value in the vicinity of a constraint satisfaction solution, by using a first solver. A constraint logic unit performs a second search for a constraint satisfaction solution in the vicinity of an annealing solution obtained by the annealing unit, by using a second solver, and performs iterative processing of the first search and the second search to obtain an optimum solution.

### CROSS REFERENCE TO RELATED APPLICATIONS

This application claims priority to Japanese Patent Application No. 2024-007549, filed Jan. 22, 2024, the contents of which are incorporated herein by reference in its entirety for all purposes.

### BACKGROUND OF THE INVENTION

### 1. Field of the Invention

The present invention relates to an optimization system, an optimization method, and an optimization program.

### 2. Description of the Related Art

In recent years, complementary metal oxide semiconductor (CMOS) annealing, which is a pseudo quantum calculation technique for solving a combination optimization problem, has attracted attention.

In CMOS annealing, an optimization problem is expressed by an Ising model, and this ground state is searched by a method called annealing. When a problem in a real world tried to be solved by annealing, various constraint conditions may have to be satisfied. In such a case, it is generally known to adopt a method of aiming at satisfaction in a process of lowering an objective function value by incorporating a constraint condition as an objective function of an Ising model as a penalty term of a second order or less.

However, in the above method, satisfaction of the constraint condition is not guaranteed, and a solution in which the constraint condition is broken may be derived. This is because, in the method of imposing a penalty in a case where the constraint condition is broken, the constraint is tried to be kept as much as possible, but only the solution space satisfying the constraint condition is not necessarily searched for.

There is known a method of satisfying the penalty term as much as possible by increasing the contribution of the penalty term to the objective function. This can be implemented by increasing the coefficient of the penalty term, but if the coefficient of the penalty term is excessively increased in order to prioritize the constraint satisfaction, the value of the objective function is not improved, and it becomes difficult to obtain an optimum solution or a solution close to the optimum solution. On the other hand, if the weight of the penalty term is reduced, the constraint is broken, and thus there is a problem that it is difficult to adjust the coefficient.

Regarding this problem, JP 2023-121046 A proposes a solution using an ADMM (alternating direction multiplier method) as a technique for satisfying a linear inequality constraint in annealing.

JP 2023-121046 A discloses a method for solving a mixed binary quadratic programming problem that satisfies a linear inequality constraint by processing the linear inequality constraint with a Hildreth algorithm by an ADMM in which annealing and the Hildreth algorithm are incorporated by using a Lagrange function method.

### SUMMARY OF THE INVENTION

However, J P 2023-121046 A is a method for searching for a solution while satisfying the linear inequality constraint with the Hildreth algorithm, but it is difficult to satisfy a constraint condition that has difficulty in express by the linear inequality constraint, such as a constraint applied only in a case where a logical constraint or a certain condition is satisfied. Further, there is a problem that, in order to solve the mixed binary quadratic programming problem while satisfying complicated constraints, continuous optimization disclosed in JP 2023-121046 A takes too much time, and the solution is delayed.

An object of the present invention is to solve a binary quadratic optimization problem including a complex logical constraint without breaking the constraint in an optimization system.

According to an aspect of the present invention, an optimization system searches for an optimum solution of a mixed binary quadratic programming problem with a constraint condition, the optimization system including: an annealing unit that performs a first search for an annealing solution for lowering a value of an objective function of the mixed binary quadratic programming problem; and a constraint logic unit that performs a second search for a constraint satisfaction solution that satisfies the constraint condition. The annealing unit performs, by using a first solver, the first search for the annealing solution to lower the value of the objective function in a vicinity of the constraint satisfaction solution. The constraint logic unit performs, by using a second solver, the second search for the constraint satisfaction solution in a vicinity of the annealing solution obtained by the annealing unit, and performing iterative processing of the first search and the second search to obtain the optimum solution.

According to the aspect of the present invention, it is possible to solve a binary quadratic optimization problem including a complex logical constraint without breaking the constraint in an optimization system.

### BRIEF DESCRIPTION OF THE DRAWINGS

FIG. 1 is a conceptual diagram illustrating a relationship between a variable array and an objective function value of an optimization problem;

FIG. 2 is a diagram illustrating a functional configuration of an optimization system according to an embodiment;

FIG. 3 is a diagram illustrating a hardware configuration of the optimization system according to the embodiment;

FIG. 4 is a flowchart of optimization processing in the optimization system according to the embodiment;

FIG. 5 is a diagram illustrating an example of a file describing a logical constraint;

FIG. 6 is a diagram illustrating an example of a correspondence table of a logical constraint function;

FIG. 7 is a diagram illustrating an example of a correspondence table of a channel constraint;

FIG. 8 is a diagram illustrating an example of a correspondence table of a variable description portion;

FIG. 9 is a diagram illustrating a correspondence between a description file of a logical constraint and an actual logical constraint function;

FIG. 10 is a diagram illustrating a correspondence between a description file of a logical constraint including a channel constraint and an actual logical constraint function;

FIG. 11 is a diagram illustrating a correspondence between a description file of a logical constraint and an actual logical constraint function;

FIG. 12 is a diagram for describing an operation for obtaining an optimum solution (convergence solution); and

FIG. 13 is a diagram illustrating an example of contents output by an output unit.

### DESCRIPTION OF THE PREFERRED EMBODIMENTS

Hereinafter, embodiments will be described with reference to the drawings. The embodiments are examples for describing the present application including the drawings. In the embodiments, omission and simplification are appropriately made for clarity of description. Unless otherwise specified, each constituent element of the embodiment may be singular or plural.

The same or similar constituent elements are denoted by the same reference numerals, and the description of the foregoing embodiments may be omitted or centered on differences.

In a case where there are a plurality of the same or similar constituent elements, the same reference numerals may be attached with different subscripts for description. In addition, in a case where it is not necessary to distinguish the plurality of constituent elements, the description may be made by omitting the subscript.

In the embodiments, processing performed by executing a program may be described. A computer performs processing determined by a program using a storage resource (for example, a memory) or the like by a processor (for example, a central processing unit (CPU) or a graphics processing unit (GPU)).

Therefore, the subject of the processing performed by executing the program may be the processor. Similarly, the subject of the processing performed by executing the program may be a controller, a device, a system, a computer, or a node having the processor. The subject of the processing performed by executing the program may be an arithmetic unit, and may include a dedicated circuit that performs specific processing.

Here, the dedicated circuit is, for example, a field programmable gate array (FPGA), an application specific integrated circuit (ASIC), a complex programmable logic device (CPLD), or the like.

The program may be installed on a computer from a program source. The program source may be, for example, a non-transitory storage medium readable by a program distribution server or a computer. In a case where the program source is a program distribution server, the program distribution server may include a processor and a storage resource (storage) that stores a distribution target program, and the processor of the program distribution server may distribute the distribution target program to another computer.

In the embodiments, two or more programs may be implemented as one program, or one program may be implemented as two or more programs.

In the following embodiments, various types of information will be described in a table format, but the various types of information may be in a data format other than the table format. Furthermore, for example, various names such as “XX information”, “XX table”, “XX list”, and “XX queue” are interchangeable therebetween. For example, “XX table” may be referred to as “XX list”. In describing identification information, expressions such as “identification information”, “identifier”, “name”, “ID”, and “number” are used, but such expressions can be replaced with each other.

In the following embodiments, for example, in a configuration of a system, components other than main components such as a processor and a memory will not be illustrated and described, and elements and processes related to the technique of the present disclosure will be mainly illustrated and described.

A solution of a constrained mixed binary quadratic programming problem using the alternating direction multiplier method will be described. Math. 1 as follows is considered as the constrained mixed binary quadratic programming problem.

$${min}_{x ∈ {\{ 0 , 1 \}}^{p} , y ∈ {\{ 0 , 1 \}}^{q}} f ( x ) + g ( y ) \qquad [ Math . 1 ]$$

$$s . t . Ax + By = 0 , ξ ( x ) \leq 0 const \{ {C}^{0} , , , {C}^{γ} \}$$

The set X: ={{xi}i=1, . . . , p} and the set Y: ={{yi} i=1, . . . , q} are sets of binary variables. It is assumed that x and y satisfy the constraint that Ax+By=0. This is a constraint that defines a relationship between the problems divided into f and g. ξ(x)≤0 is an inequality constraint to be satisfied by x, const {C° . . . C^{r}} is various constraints such as a logical constraint and a channel-constrained logical constraint, and this constraint is processed by a constraint logic unit to be described later. f(x) and g(y) include quadratic unconstrained binary optimization (QUBO (unconstrained mixed binary quadratic optimization problem)) and mixed-binary quadratic programming (QP, mixed binary quadratic programming problem). An indication function IS for the set S is defined as follows.

$${I}_{S} ( x ) = \{ \begin{matrix}0 & x ∈ S \\ ∞ & Otherwise\end{matrix} \qquad [ Math . 2 ]$$

When Math. 2 is used and A=I and B=−I (I is a unit matrix) are set, Math. 1 can be expressed as follows. Here, a vector v=x−y is introduced, and an augmented Lagrange function is defined as follows.

$${L}_{ρ} ( x , y , v , γ , λ ) = f ( x ) + {I}_{X} ( x ) + g ( y ) + {I}_{γ} ( y ) + \frac{γ}{2} {‖ x - y ‖}_{2}^{2} + {λ}^{T} ( x - y - v ) + \frac{ρ}{2} {‖ x - y - v ‖}_{2}^{2} \qquad [ Math . 3 ]$$

At this time, the problem of Math. 1 can be described as follows.

$${min}_{x ∈ {\{ 0 , 1 \}}^{p} , y ∈ {\{ 0 , 1 \}}^{q}} {L}_{ρ} ( x , y , v , γ , λ ) \qquad [ Math . 4 ]$$

$${L}_{ρ} ( x , y , v , γ , λ ) = f ( x ) + {I}_{X} ( x ) + g ( y ) + {I}_{Y} ( y ) + \frac{γ}{2} {‖ v ‖}_{2}^{2} + {λ}^{T} ( x - y - v ) + \frac{ρ}{2} {‖ x - y - v ‖}_{2}^{2}$$

$$X := \{ x ∈ \{ 0 , 1 \} \vert ξ ( x ) \leq 0 , const \{ {C}^{0} , , , {C}^{r} \} \}$$

$$Y := \{ y ∈ \{ 0 , 1 \} \vert ξ ( y ) \leq 0 , const \{ {C}^{0} , , , {C}^{r} \} \}$$

It is known that, if the following optimization calculation is iterated in accordance with the alternating direction multiplier method, x and y when p is sufficiently large converge to a certain point, as shown in Math. 5. k indicates the number of iterations described above, and for example, x^{k} is a value of x of k-th iterative calculation.

$$x ← {argmin}_{x ∈ {\{ 0 , 1 \}}^{p}} {L}_{ρ} ( x , {y}^{k - 1} , {v}^{k - 1} , {γ}^{k} , {λ}^{k} ) \qquad [ Math . 5 ]$$

$$y ← {argmin}_{y ∈ {\{ 0 , 1 \}}^{q}} {L}_{ρ} ( {x}^{k} , y , {v}^{k - 1} , {γ}^{k} , {λ}^{k} )$$

$${v}^{k} ← \frac{{λ}^{k} + {ρ}^{k} ( {x}^{k} - {y}^{k} )}{{γ}^{k} + {ρ}^{k}}$$

A specific calculation method of Math. 5 will be described below. The first equation of Math. 5 can be modified as in Math. 6. That is, it results in an unconstrained mixed binary quadratic programming problem in a case where the coefficient matrix of the quadratic term of the equation is J˜: =J−ρI, the coefficient vector of the linear term is h˜: =h+ρ(y+v)−λ, and x is moved with y fixed.

Here, I is an identity matrix. This optimization problem can be efficiently solved by Markov chain Monte Carlo method (MCMC).

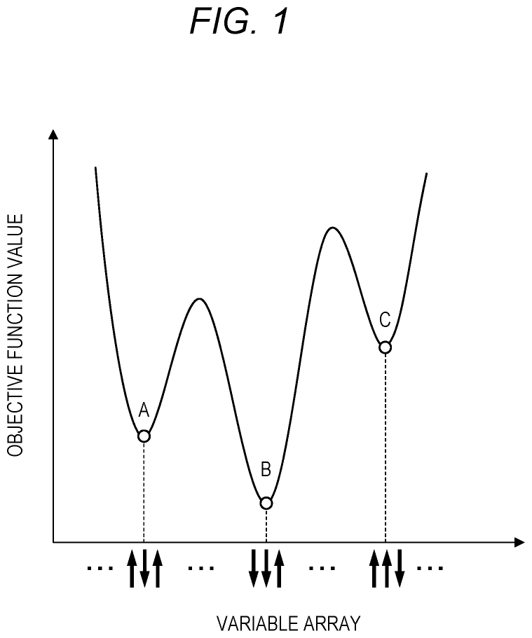

FIG. 1 is a conceptual diagram illustrating a relationship between a variable array and an objective function value of an optimization problem, and illustrates a landscape of the objective function value with respect to the variable array.

The horizontal axis of the graph represents the variable array x, and the vertical axis represents the value of an objective function −½. xJx−hx. The MCMC iterates a stochastic transition from the current state x to a certain state x′ in the vicinity of the state x. The probability of transition from the state x to the state x′ is referred to as a transition probability P (x, x′). Examples of the transition probability P include a metropolis method and a heat-bath algorithm. The transition probability has a parameter called temperature, which represents the ease of transition between states.

When MCMC is performed while gradually decreasing the temperature from a large value, the state converges to a state where the objective function value is the lowest (state of lowest energy, B in FIG. 1). A method for obtaining an optimum solution or an approximate solution of an optimization problem using this is simulated annealing (referred to as simulated annealing (SA) below).

$${argmin}_{x ∈ {\{ 0 , 1 \}}^{p}} {L}_{ρ} ( x , {y}^{k - 1} , {v}^{k - 1} , {γ}^{k} , {λ}^{k} ) = {argmin}_{x ∈ X} \{ - \frac{1}{2} {x}^{T} {\tilde{J}}_{i , j} x - {\tilde{h}}^{T} x \} \qquad [ Math . 6 ]$$

$$J := J - {ρ}^{k} I$$

$$\tilde{h} := h + {ρ}^{k} y + {ρ}^{k} {v}^{k - 1} - {λ}^{k}$$

The second equation of Math. 5 can be expressed as Math. 7 by using the vector c=x−y+λ/ρ. x is x obtained immediately before from the first equation of Math. 5. That is, this results in a constrained mixed binary quadratic programming problem in a case where x is fixed and y is moved.

$${argmin}_{y ∈ {\{ 0 , 1 \}}^{q}} {L}_{ρ} ( {x}^{k} , y , {v}^{k - 1} , {γ}^{k} , {λ}^{k} ) = {argmin}_{y ∈ Y} \sum ( - {c}_{i} {y}_{i} ) \qquad [ Math . 7 ]$$

$$c = {x}^{k} - {y}^{k - 1} + \frac{{λ}^{k}}{{ρ}^{k}}$$

$$s . t . L \leq Dy \leq U const \{ {C}^{0} , , , {C}^{r} \}$$

The third equation of Math. 5 is a calculation equation for updating the vector v by using x and y obtained immediately before from the first and second equations of Math. 5 and the vector v before the update.

In the above iterative calculation, an update equation of various parameters for the next calculation is shown in Math. 8. The parameter used in the next (k+1)th iterative calculation is calculated by using the result obtained in the k-th iterative calculation. Here, f_{update} is a function of the parameter ρ used in the k-th iterative calculation, and a function of simply performing multiplication by one (that is, p has the same value during the iterative calculation) or a function of multiplying the k-th p by a constant can be considered. In the case of sufficiently large p, the convergence of the solution is improved, but in the case of too large p, the global solution search by the MCMC is inhibited, and the possibility of convergence to the local optimum solution increases.

Thus, it is effective to start the calculation from a sufficiently small value of p and gradually increase the value. In addition, as is clear from Math. 1 and Math. 3, when x=y and v=0 are satisfied, the constraint is satisfied and the solution converges. Thus, a function of updating p according to a change in the absolute value of v is also expected to be effective. For example, a function of selecting whether to perform multiplication by a constant or to use, in the (k+1)th calculation, the same value as that of the k-th calculation by performing multiplication by one in accordance with the solution obtained in the k-th calculation can be considered.

$${λ}^{k + 1} = {λ}^{k} + {ρ}^{k} ( {x}^{k} - {y}^{k} - {v}^{k} ) \qquad [ Math . 8 ]$$

$${ρ}^{k + 1} = {f}_{update} ( {ρ}^{k} )$$

$${γ}^{k + 1} = {αρ}^{k}$$

In the update equation of γ in Math. 8, α is desirably determined between 0 and 1. Empirically, high convergence is exhibited when the value is close to 1.

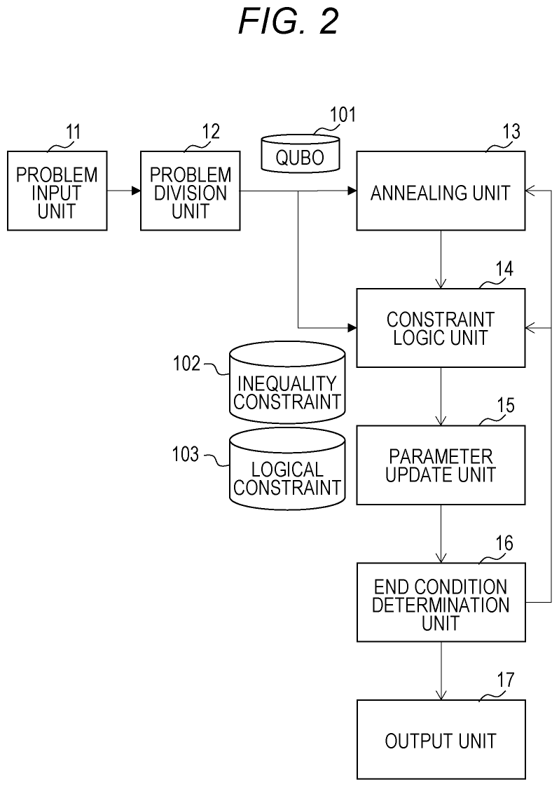

FIG. 2 is a diagram illustrating a functional configuration for implementing the optimization system according to the embodiment.

The optimization system includes functional blocks of a problem input unit 11, a problem division unit 12, an annealing unit 13, a constraint logic unit 14, a parameter update unit 15, an end condition determination unit 16, and an output unit 17.

The problem input unit 11 has a function of inputting a mixed binary quadratic programming problem represented by Math. 1 to Math. 3 to an information processing apparatus. At that time, the problem input unit 11 has a function of inputting the definition of a determination variable x, the definitions of the objective functions f and g, and the definitions of various constraint conditions together in the form of a mathematical equation in accordance with the problem intended to be solved.

The problem division unit 12 has a function of dividing the problem input by the problem input unit 11 into a mathematical equation to be solved by the annealing unit 13 and a mathematical equation to be solved by the constraint logic unit 14 and outputting the divided mathematical equations. Specifically, a QUBO equation 101 is output to the annealing unit 13, and an inequality constraint 102 and a logical constraint 103 are output to the constraint logic unit 14. The format of the output may be a file or a memory, but, in general, the amount of information reaches several 1 million lines depending on the problem to be solved, and thus transfer in a file is preferable.

As illustrated in FIG. 1, the annealing unit 13 performs a solution search for the minimum energy on a state space. As an algorithm at this time, an annealing method based on MCMC is used. The problem solved by the annealing unit 13 is as shown in Math. 6. The QUBO equation 101 transferred from the problem division unit 12 is represented by Jᵢⱼ or h in Math. 6.

The constraint logic unit 14 is a functional block that solves the problem represented by Math. 7 using the inequality constraint 102 and the logical constraint 103 output from the problem division unit 12. Here, the inequality constraint 102 gives the vectors L, U and the matrix D in L≤Dy≤U in Math. 7. The logical constraint 103 gives Const (C⁰, C¹, C^{r}). Here, r is the number of logical constraints. The objective function in the calculation of the constraint logic unit 14 does not necessarily include the objective function in the problem input by the problem input unit 11.

However, an objective function Σ(−cy) derived from the augmented Lagrange function method is necessarily included. A SAT type constraint satisfaction solver is used as an example of the solution search of the determination variable y. The present invention is not limited thereto, and any solver may be used as long as the solver operates in accordance with an algorithm having a function of minimizing the objective function expressed by Math. 7 while satisfying the inequality constraint and the logical constraint expressed by the binary variable.

The parameter update unit 15 updates an update equation of v expressed by the third equation of Math. 5, λ, ρ, and γ shown in Math. 8. The parameter updated here is used in the next iterative calculation, and thus has a feedback path to the annealing unit 13 and the constraint logic unit 14. Here, one iterative calculation includes a series of calculations in a series of functional blocks of the annealing unit 13, the constraint logic unit 14, the parameter update unit 15, and the end condition determination unit 16.

The end condition determination unit 16 determines whether to perform the next iterative calculation or end the optimization calculation in response to the result of the parameter update unit 15. As the criterion for the determination, a case where the iterative calculation of a predetermined number of times has been ended, a case where a predetermined constant time has elapsed, a case where the update of the solution or the update of the objective function value has not been found a predetermined number of times, a case where the value of a convergence error x-y in Math. 4 becomes equal to or less than a predetermined value, or the like can be considered.

The output unit 17 has a function of outputting the obtained solution after the end condition determination unit 16 determines that the optimization calculation has been ended. For the output, various methods such as a case where a result is displayed on a screen and a case where the result is output to a file can be considered. In addition, it is assumed that a case where the output becomes an input to a larger system includes a case where a result is output to the system by communication or the like.

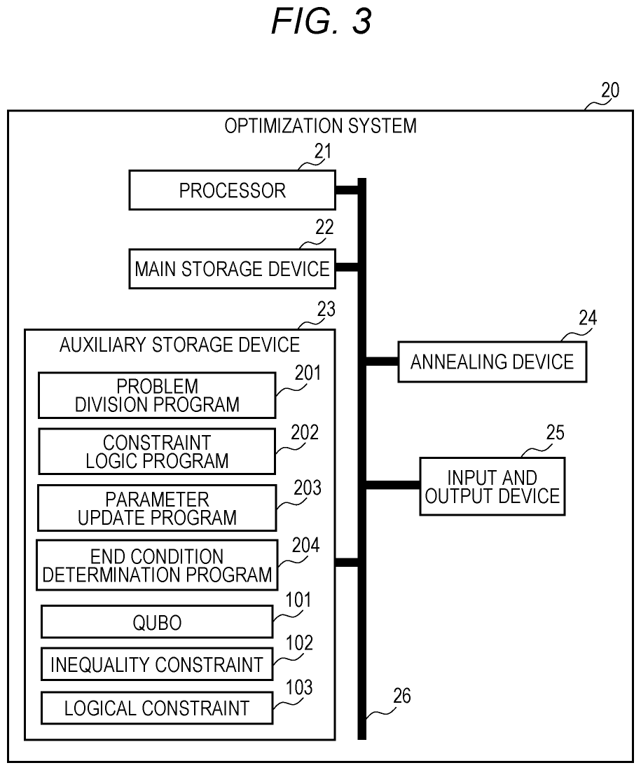

FIG. 3 is a diagram illustrating hardware of a computer that implements an optimization system 20 according to the embodiment.

The optimization system 20 includes, as hardware, a processor 21, a main storage device 22, an auxiliary storage device 23, an annealing device 24, an input and output device 25, and a system bus 26 that communicably connects these devices.

For example, a part or the entirety of the optimization system 20 may be implemented by using a virtual information processing resource such as a cloud server provided by a cloud system. The optimization system 20 may be implemented by, for example, a plurality of information processing apparatuses that operate in cooperation with each other and are communicably connected.

The processor 21 controls the entire optimization system 20, refers to data in the main storage device 22, and executes a program loaded in the main storage device 22. For example, the processor 21 is configured by using a central processing unit (CPU) or a micro processing unit (MPU).

The main storage device 22 is a volatile storage device that stores programs and data, and is, for example, a read only memory (ROM), a static random access memory (SRAM), a non-volatile RAM (NVRAM), a mask read only memory (ROM), a programmable ROM (PROM), a random access memory (RAM), a dynamic random access memory (DRAM), or the like.

The auxiliary storage device 23 is a non-volatile mass storage device, and is, for example, a hard disk drive (HDD), a flash memory, a solid state drive (SSD), an optical storage device (compact disc (CD), digital versatile disc (DVD), and the like), or the like. Programs and data stored in the auxiliary storage device 23 are read out to the main storage device 22 at any time.

In the auxiliary storage device 23, a problem division program 201, a constraint logic program 202, a parameter update program 203, and an end condition determination program 204 are installed. The problem division program 201, the constraint logic program 202, the parameter update program 203, and the end condition determination program 204 are programs that execute the functions of the problem division unit 12, the constraint logic unit 14, the parameter update unit 15, and the end condition determination unit 16, respectively.

In addition, the auxiliary storage device 23 stores the QUBO equation 101, the inequality constraint 102, and the logical constraint 103.

The annealing device 24 is a device that has the function of the annealing unit 13 and performs processing related to an optimum solution search of a combination optimization problem. For example, it may take the form of an extension card attached to the optimization system 20, such as a graphic processing unit (GPU). The annealing device 24 is configured by, for example, hardware such as a complementary metal oxide semiconductor (CMOS) circuit, an FPGA, or an ASIC.

The annealing device 24 includes a control device, a storage device, an interface for a connection to the system bus 26, and the like, and transmits and receives commands and information to and from the processor 21 via the system bus 26. The annealing device 24 may be, for example, communicably connected to another annealing device 24 via a communication line and operate in cooperation with the other annealing device 24. The function implemented by the annealing device 24 may be implemented, for example, by causing the processor 21 to execute a program.

The input and output device 25 includes a user interface that receives an input of information from a user and a user interface that outputs a calculation result. Examples of the input device include a keyboard, a mouse, a card reader, a touch panel, and the like. The output device is, for example, a display device (liquid crystal display (LCD), graphic card, and the like) that visualizes various types of information, a sound output device (speaker), a printing device, or the like. The input and output device 25 executes the functions of the problem input unit 11 and the output unit 17. Instead of the input and output device 25, an input device and an output device may be provided.

In the optimization system 20, the program is read from the auxiliary storage device 23 and executed by cooperation of the processor 30 and the main storage device 22, so that the function of the optimization system 20 is implemented. Alternatively, the program for implementing the function of the optimization system 20 may be acquired from an external computer by communication. Alternatively, the program for implementing the function of the optimization system 20 may be recorded in a portable recording medium (optical disk, magnetic disk, magnetic optical disk, semiconductor storage medium, or the like), and read by a medium reading device.

Furthermore, the optimization system 20 may be an information processing system in which a plurality of devices cooperatively execute processing. The program for implementing the information processing system implements the similar functions to those of the optimization system 20 by each program causing each device to implement each function.

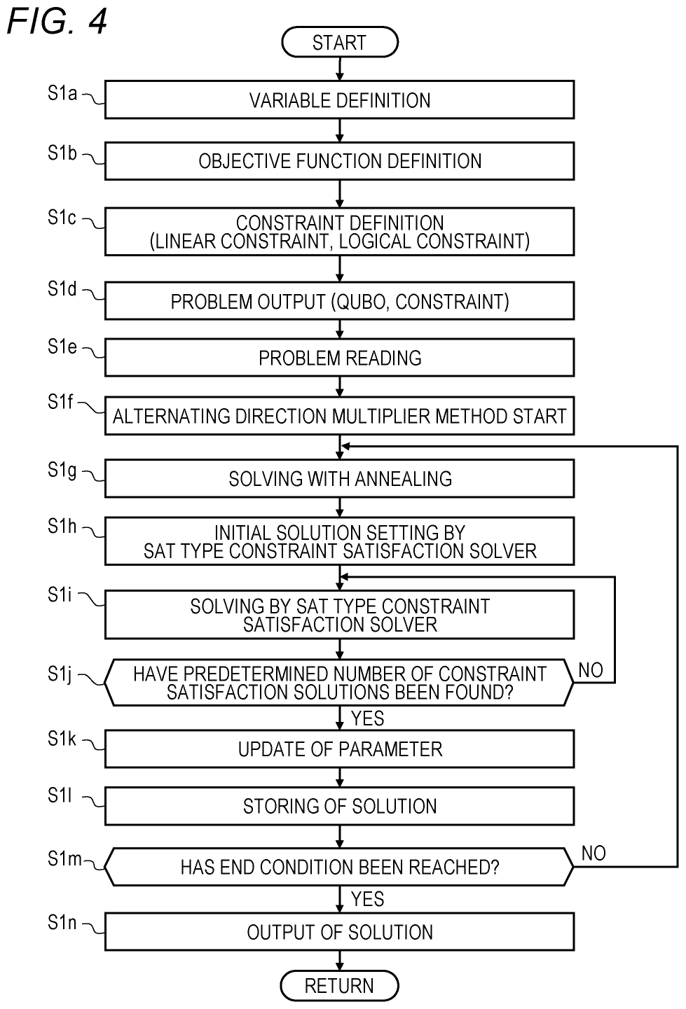

FIG. 4 illustrates an overall flow of optimization processing.

First, variable definition Sla is performed. Here, the variable is an amount or an index intended to be optimized in the optimization problem. The variable is x and y in Math. 1 to Math. 3.

Then, objective function definition S1b is performed. An optimization target is expressed and defined as an objective function by using the defined variable. Then, constraint definition S1c is performed. The constraint condition is expressed in the form of a linear constraint and a logical constraint as illustrated in FIG. 2. Generally, the constraints in the optimization problem of the real world are often described in a natural language, and are described and defined by expressing the constraints by mathematical equations.

The variable definition Sla, the objective function definition S1b, and the constraint definition S1c are performed by the input and output device 25 that executes the functions of the problem input unit 11 in the optimization system 20.

Since the objective function and the constraint condition of the problem can be defined so far, problem output S1d for optimization is performed. QUBO and constraints are output. As illustrated in FIG. 2, the constraint is output separately into a linear constraint and a logical constraint. The optimization program and the program describing the problem are often separated, and the above description is made in a script language for problem definition. For example, it is often described as a Python script.

The problem output S1d is performed on the problem input by the problem input unit 11 in the problem division unit 12 implemented by the processor 21 reading the problem division program 201 in the optimization system 20, and outputs the QUBO equation 101, the inequality constraint 102, and the logical constraint 103, respectively.

Then, problem reading S1e for reading a problem with the optimization program is performed. QUBO and constraint output as a file as an example of the problem reading S1e are loaded onto the auxiliary storage device 23 in this flow. Then, an optimization procedure is started, and the alternating direction multiplier method is started (S1f). As a first step of the alternating direction multiplier method, solving with annealing is performed (S1g). Here, the optimization calculation described in Math. 6 is performed by annealing. The solving with annealing Sig is performed by the annealing device 24 in the optimization system 20.

After the calculation in annealing has been ended, an initial solution is set in, for example, a SAT type constraint satisfaction solver (S1h). An object of this is to give a hint that a constraint satisfaction solution is easily found in order to shorten a time for the SAT type constraint satisfaction solver to first find the constraint satisfaction solution.

For example, it is assumed that, in the first time of the loop of the alternating direction multiplier method, a hint based on annealing is given, and in the second and subsequent times, the best constraint satisfaction solution obtained by the SAT type constraint satisfaction solver in the previous time (the solution when the objective function value minimized by the SAT type constraint satisfaction solver becomes the smallest) is given as the hint. Here, the hint based on annealing means that an annealing solution is used as a hint for a solution search of the SAT type constraint satisfaction solver. As another manner of giving a hint, there is a manner of externally inputting and utilizing a constraint satisfaction solution obtained in advance. In addition, it has been understood that the SAT type constraint satisfaction solver tends to be slow in finding the first constraint satisfaction solution when it becomes a large-scale problem. Therefore, in order to shorten the search time for the first constraint satisfaction solution, there is a high possibility that the search time can be shortened by excluding the objective function in the solution search of the SAT type constraint satisfaction solver in the first iterative calculation of the alternating direction multiplier method.

Then, solving by the SAT type constraint satisfaction solver is performed (S1i). In the solving with the SAT type constraint satisfaction solver, it may take a very long time to search for an optimum solution. In particular, in a case of handling a large-scale problem in the real world, there is a case where the solution search is continued even though an optimum solution is searched and an executable solution is obtained. In this case, since the calculation time is prolonged, it may be a disadvantage in terms of operation. Therefore, it is determined in S1j whether a predetermined number of constraint satisfaction solutions have been found, and, in a case where the condition is satisfied, the solution search of the SAT type constraint satisfaction solver is interrupted. The set number only needs to be determined based on the scale of the problem to be solved or the time scale that can be used for calculation.

The processes S1h to S1i related to the SAT type constraint satisfaction solver described above are executed after the inequality constraint 102 and the logical constraint 103 are read by the constraint logic unit 14 implemented by the processor 21 reading the constraint logic program 202 in the optimization system 20.

In a case where a predetermined number of solutions are found in the solution search by the SAT type constraint satisfaction solver, update S1k of parameter is performed. The solution obtained thereafter is stored (S1l). There are various conceivable methods such as a method of storing all the obtained solutions and a method of storing only the best solution as compared with the solutions obtained so far, and it is assumed that the present application includes all of these methods.

The update S1k of the parameter and the storing S1l of the solution are performed by the parameter update unit 15 implemented by the processor 21 reading the parameter update program 203 in the optimization system 20.

After the solution is stored, it is determined whether a condition of ending the iterative calculation of the alternating direction multiplier method has been reached (S1m). It is preferable to use a condition in consideration of a predetermined number of iterations, an upper limit of a predetermined calculation time, a predetermined residual error, or the like, or a condition obtained by a combination thereof. If the end condition has not been reached, the iterative calculation of the alternating direction multiplier method is continued, and solving S1g with annealing is performed again. In a case where the end condition has been reached, the process proceeds to the output Sin of the solution. In the output of the solution, all the obtained constraint satisfaction solutions may be output, or one best solution may be output. It is assumed that these are designed in accordance with the requirements to be satisfied by the optimization system.

The determination S1m of the end condition is performed by the end condition determination unit 16 implemented by the processor 21 reading the end condition determination program 204 in the optimization system 20.

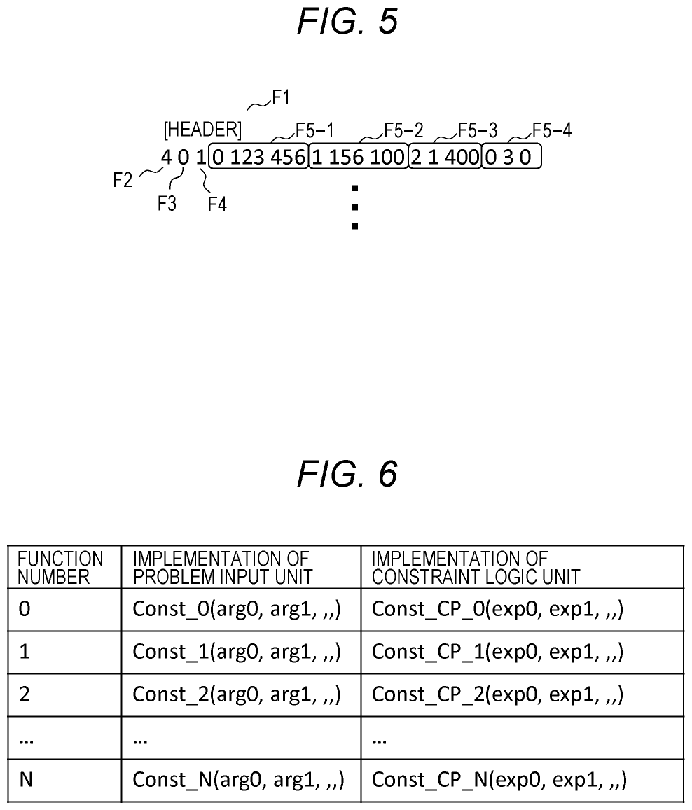

The file format of the constraint logic in FIG. 2 will be described with reference to FIGS. 5 to 8.

FIG. 5 is an example of a file format. F1 is a header of the file, and it is determined whether or not the file is a logical constraint file by the header. The format and description contents of the header are not particularly limited as long as the format and description contents can be understood. However, it is necessary to make it possible to identify the header on the optimization solver side to read the header.

In FIG. 5, all F2 to F5-4 are described in one row, and one row expresses one logical constraint. Note that all the numbers are separated by a separator such as a space, a tab, or a comma. F2 is the first number, which is a function number describing the type of function describing the logical constraint. F3 is a code indicating a channel constraint given to the logical constraint. Here, the channel constraint describes a condition for imposing the logical constraint. For example, a certain logical constraint A imposes a constraint that needs to be satisfied when the channel constraint B is true and does not need to be satisfied when the channel constraint B is false. F4 is the number of arguments of the channel constraint. F5-1 to F5-4 are argument data defining an argument to be given to the logical constraint in units of three numbers.

FIG. 6 illustrates correspondence between the function number F2 of the function describing the logical constraint in FIG. 5, implementation of the problem input unit, and implementation of the constraint logic unit.

The function numbers 0, 1, 2, . . . , and N are states in which a total of N+1 types of logical constraint functions are registered. These are managed by function numbers, and the function number, the implementation of the problem input unit, and the implementation of the constraint logic unit are in a one-to-one-to-one correspondence. These are described in, for example, specifications of the optimization system, a programming manual, a reference manual, and the like, and are referred to by a user of the optimization system that formulates the optimization problem. It is assumed that, if the user performs formulation by using the function described in the implementation of the problem input unit in FIG. 6, the problem division unit creates and outputs the format described in FIG. 5.

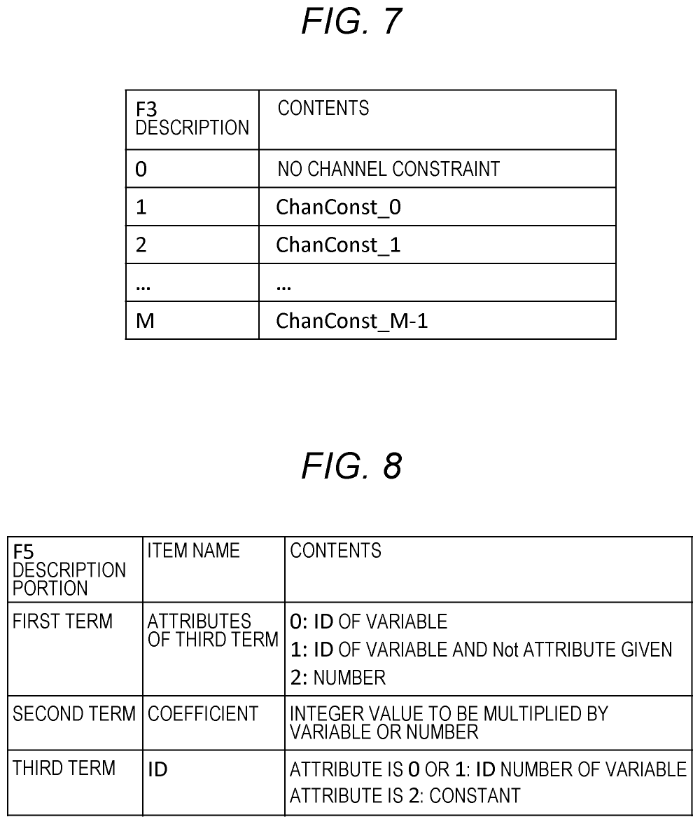

FIG. 7 is an example of a correspondence table of the code F3 indicating the channel constraint given to the logical constraint in FIG. 5 and the contents thereof.

In a case where F3 is 0, no channel constraint is imposed. In a case where the code is 1 or more, the channel constraint ChanConst_0, the channel constraint ChanConst_1, and the channel constraints ChanConst_2, . . . are imposed in order. In FIG. 7, M−1 kinds of ChanConst are registered. FIG. 7 is also information to be utilized to ascertain what channel constraints the user who performs formulation supports.

FIG. 8 illustrates what each term represents with respect to argument data of a set of logical constraints by three numbers described by F5-1 to F5-4 in FIG. 5.

The first term indicates an attribute of the third term. The case of 0 indicates a variable ID. The case of 1 indicates an ID of a variable and that the Not attribute is given to this variable. The case of 2 indicates that the third term is recognized not as a variable but as a number.

The second term indicates a coefficient to be multiplied by the third term. The third term indicates an ID number or a number of a variable although the content of the third term changes depending on the first term.

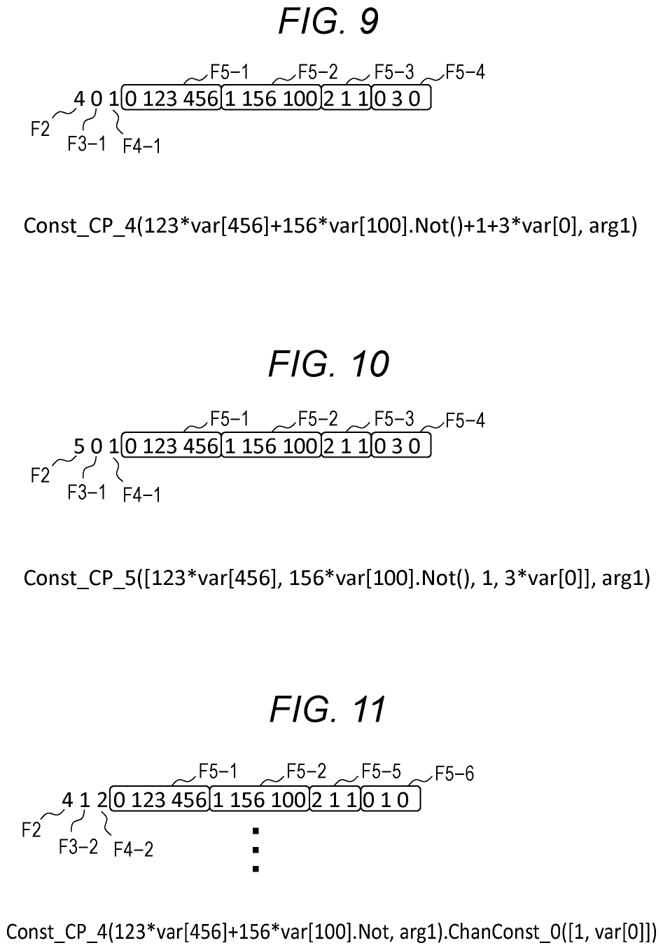

FIGS. 9 to 11 illustrate how the contents described in the logical constraint are described in the constraint logic unit. The argument data described in F5-1 to F5-4 is processed by the constraint logic unit differently if the function of the corresponding logical constraint is different even though the description is exactly the same.

For example, although the argument data of the logical constraint is exactly the same in FIGS. 9 and 10, there is a difference that the function to be applied is Const CP 4 or Const CP 5. In Const CP 4 as illustrated in FIG. 9, the argument data is used as a sum of 123*var[456]+156*var[100]. Not( )1+3*var[0]. In Const CP 5 as illustrated in FIG. 10, the argument data is used as an argument in an array form of [123*var[456], 156*var.[100].Not( ), 1, 3*var[0]]. These are determined in advance by the constraint logic unit 14, and the rules are applied.

FIG. 11 is almost the same as FIG. 9, except that the channel constraint is imposed.

As the channel constraint, for example, since F3-2 is set to 1 in FIG. 11, the channel constraint ChanConst_0 is applied, and since F4-2 is set to 2, two arguments are set to ChanConst_0.

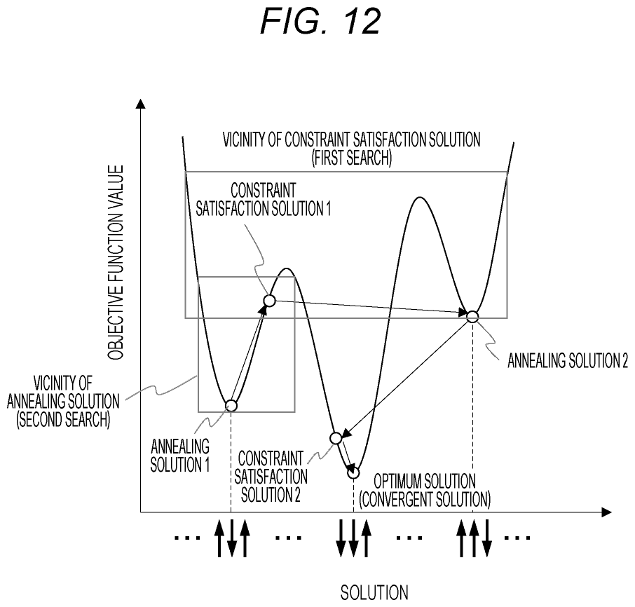

Next, an operation for obtaining an optimum solution (convergence solution) will be described with reference to FIG. 12.

As illustrated in FIG. 12, an optimum solution (convergence solution) of a mixed binary quadratic programming problem with a constraint condition is searched for.

The annealing unit 13 performs a first search for an annealing solution for lowering the value of the objective function of the mixed binary quadratic programming problem. The constraint logic unit 14 performs a second search for a constraint satisfaction solution that satisfies the constraint condition.

The annealing unit 13 performs the first search for the annealing solution to lower the objective function value in the vicinity of the constraint satisfaction solution, by using a first solver. On the other hand, the constraint logic unit 14 performs a second search for the constraint satisfaction solution in the vicinity of the annealing solution obtained by the annealing unit, by using a second solver. Then, iterative processing of the first search and the second search is performed to obtain an optimum solution (convergence solution).

An operation for obtaining an optimum solution (convergence solution) will be specifically described with reference to FIG. 12 as an example. First, the annealing unit 13 searches for an annealing solution for lowering the value of the objective function for the entire objective function as a target, and as a result, an annealing solution 1 is obtained. Then, the constraint logic unit 14 searches for a constraint satisfaction solution that satisfies the constraint condition in the vicinity (region indicated by the second search in the drawing) of the annealing solution 1 (initial solution), and as a result, a constraint satisfaction solution 1 is obtained. Subsequently, the annealing unit 13 searches for an annealing solution for lowering the value of the objective function in the vicinity (the region indicated by the first search in the drawing) of the constraint satisfaction solution 1, and as a result, a annealing solution 2 is obtained. The constraint logic unit 14 further searches for a constraint satisfaction solution that satisfies the constraint condition in the vicinity of the annealing solution 2, and as a result, a constraint satisfaction solution 2 is obtained. As described above, the first search by the annealing unit 13 and the second search by the constraint logic unit 14 are iterated until the end condition is reached, and the optimum solution is obtained.

For example, the constraint logic unit 14 performs the second search by using a SAT type constraint satisfaction solver that operates in accordance with the algorithm having a function of minimizing the value of the objective function, as the second solver. In addition, the annealing unit uses simulated annealing as the first solver, but may be another metaheuristic algorithm that heuristically searches for a solution (approximate solution) close to a solution for minimizing the value of the objective function.

Here, an operation of searching a range close to the state and the energy and updating the next solution is referred to as a neighborhood search. As illustrated in FIG. 12, an optimum solution (convergence solution) is obtained by alternately iterating the first search for searching for a low energy solution in the vicinity of the solution obtained by the SAT type constraint satisfaction solver and the second search for searching for the constraint satisfaction solution in the vicinity of the solution obtained by annealing.

As described above, in the above embodiment, QUBO is solved by annealing, and logical constraints that are difficult to be satisfied by annealing, a linear programming solver, and a known continuous optimization algorithm are solved as a problem of constraint logic while being satisfied by the second solver (SAT type constraint satisfaction solver). In annealing, the solution that can lower the objective function value is searched in the vicinity of the solution obtained by the solution of the SAT type constraint satisfaction solver, and the SAT type constraint satisfaction solver searches for the solution that satisfies the constraint in the vicinity of the solution obtained by annealing. This is alternately iterated to obtain a final constraint satisfaction solution.

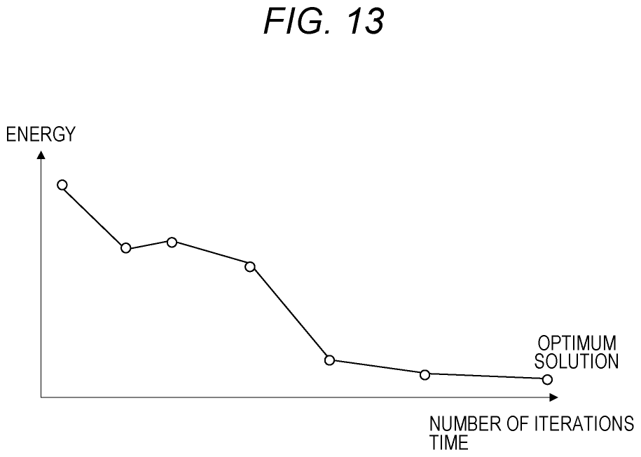

An example of contents output by the output unit 17 will be described with reference to FIG. 13.

As illustrated in FIG. 13, the output unit 17 displays, for example, a process until an optimum solution is obtained as a graph. Here, the vertical axis of the graph represents energy, and the horizontal axis represents the number of iterations or the iteration time. By performing the iterative processing of the first search and the second search (see FIG. 12), the energy is gradually lowered, and an optimum solution (convergence solution) is obtained.

According to the above embodiment, it is possible to obtain a constraint satisfaction solution that is difficult to be derived by annealing alone. Furthermore, it is possible to solve a mixed binary quadratic programming problem that cannot be solved by a SAT type constraint satisfaction solver alone.

As described above, according to the above embodiment, it is possible to obtain a solution that satisfies a logical constraint or a constraint applied only in a case where a certain condition is satisfied in the mixed binary quadratic programming problem, and it is possible to solve a binary quadratic optimization problem including a complicated logical constraint accompanied by a channel constraint without breaking the constraint.

The above embodiment is applicable to, for example, crew operation planning, equipment operation planning, scheduling optimization, financial portfolio optimization, and the like.

What is claimed is:

1. An optimization system that searches for an optimum solution of a mixed binary quadratic programming problem with a constraint condition, the optimization system comprising:
an annealing unit that performs a first search for an annealing solution for lowering a value of an objective function of the mixed binary quadratic programming problem; and
a constraint logic unit that performs a second search for a constraint satisfaction solution that satisfies the constraint condition, wherein
the annealing unit
performs, by using a first solver, the first search for the annealing solution to lower the value of the objective function in a vicinity of the constraint satisfaction solution, and
the constraint logic unit
performs, by using a second solver, the second search for the constraint satisfaction solution in a vicinity of the annealing solution obtained by the annealing unit, and
performs iterative processing of the first search and the second search to obtain the optimum solution.

2. The optimization system according to claim 1, wherein
the constraint logic unit
performs the second search by using, as the second solver, a SAT type constraint satisfaction solver that operates in accordance with an algorithm having a function of minimizing the value of the objective function.

3. The optimization system according to claim 1, wherein
the constraint logic unit
ends the second search in a case where a predetermined number of the constraint satisfaction solutions have been found.

4. The optimization system according to claim 1, wherein
the constraint logic unit
ends the second search in a case where a predetermined solution search time has elapsed.

5. The optimization system according to claim 1, further comprising:
a problem input unit;
a problem division unit;
a parameter update unit;
an end condition determination unit; and
an output unit, wherein
the problem input unit
inputs the mixed binary quadratic programming problem,
the problem division unit
divides and outputs the mixed binary quadratic programming problem input by the problem input unit into a QUBO equation to be solved by the annealing unit and a constraint equation to be solved by the constraint logic unit,
the annealing unit
performs the first search for the annealing solution by using the QUBO equation,
the constraint logic unit
performs the second search for the constraint satisfaction solution by using the constraint equation,
the parameter update unit
updates a predetermined parameter and feeds the predetermined parameter back to the annealing unit and the constraint logic unit, and
the end condition determination unit
determines whether to end the iterative processing of the first search and the second search based on a result of the parameter update unit, based on a predetermined end condition,
performs the iterative processing of the first search in the annealing unit and the second search in the constraint logic unit in a case where it is determined not to end the iterative processing based on the predetermined end condition, and
outputs the optimum solution to the output unit in a case where it is determined to end the iterative processing based on the predetermined end condition.

6. The optimization system according to claim 5, wherein
the problem input unit
performs conversion processing of converting the mixed binary quadratic programming problem into an augmented Lagrange function having a first variable vector and a second variable vector including the objective function, the constraint equation, and a penalty term based on the constraint equation as variables,
the problem division unit
converts the objective function and the penalty term into the QUBO equation, transmits the QUBO equation to the annealing unit, and transmits the constraint equation to the constraint logic unit,
the annealing unit
searches for an optimum solution of the first variable vector that optimizes the augmented Lagrange function in an alternating direction multiplier method, by using a predetermined optimization algorithm of the mixed binary quadratic programming problem,
the constraint logic unit
searches for an optimum solution of the second variable vector that optimizes the augmented Lagrange function in the alternating direction multiplier method, by using the SAT type constraint satisfaction solver to satisfy the constraint equation, and
the parameter update unit
updates a parameter of the augmented Lagrange function and feeds the parameter of the augmented Lagrange function back to the annealing unit and the constraint logic unit.

7. The optimization system according to claim 6, wherein
the problem division unit
divides the constraint equation into an inequality constraint and a logical constraint and transmits the inequality constraint and the logical constraint to the constraint logic unit.

8. The optimization system according to claim 7, wherein
the logical constraint includes a channel constraint, and
the channel constraint describes a condition to be satisfied by the logical constraint.

9. The optimization system according to claim 8, wherein
the logical constraint has a format expressing one constraint in one row, and is configured to include ID information of a function of the logical constraint, ID information of the channel constraint, information of the number of variables input to the channel constraint, and variable information included in the logical constraint and the channel constraint.

10. The optimization system according to claim 9, wherein
the variable information includes
an attribute of the variable, a coefficient to be multiplied by the variable, and the variable,
the attribute of the variable
defines whether the variable is a variable, a variable to which a NOT attribute is given, or a constant, and
the variable
represents one of a variable corresponding to the attribute of the variable, the variable to which the NOT attribute is given, and the constant.

11. The optimization system according to claim 5, wherein
the end condition determination unit
iterates the iterative processing a predetermined number of times as the predetermined end condition.

12. The optimization system according to claim 5, wherein
the end condition determination unit
iterates the iterative processing until a predetermined time elapses, as the predetermined end condition.

13. The optimization system according to claim 5, wherein
the output unit
displays a process of obtaining the optimum solution by performing the iterative processing of the first search and the second search, as a graph.

14. An optimization method for searching for an optimum solution of a mixed binary quadratic programming problem with a constraint condition, the optimization method comprising:
performing a first search for an annealing solution for lowering a value of an objective function of the mixed binary quadratic programming problem by an annealing unit; and
performing a second search for a constraint satisfaction solution that satisfies the constraint condition by a constraint logic unit, wherein
in the performing of the first search, the first search for the annealing solution is performed to lower the value of the objective function in a vicinity of the constraint satisfaction solution, by using a first solver,
in the performing of the second search,
the second search for the constraint satisfaction solution is performed in a vicinity of the annealing solution obtained by the annealing unit, by using a second solver, and
iterative processing of the first search and the second search is performed to obtain the optimum solution.

15. An optimization program for searching for an optimum solution of a mixed binary quadratic programming problem with a constraint condition, the optimization program causing a computer to function as:
an annealing function that performs a first search for an annealing solution for lowering a value of an objective function of the mixed binary quadratic programming problem; and
a constraint logic function that performs a second search for a constraint satisfaction solution that satisfies the constraint condition, wherein
the annealing function
performs, by using a first solver, the first search for the annealing solution to lower the value of the objective function in a vicinity of the constraint satisfaction solution, and
the constraint logic function
performs, by using a second solver, the second search for the constraint satisfaction solution in a vicinity of the annealing solution obtained by the annealing function, and
performs iterative processing of the first search and the second search to obtain the optimum solution.
